(19) United States
(12) Patent Application Publication
(10) Pub. No.: US 2019/0090518 A1
(43) Pub. Date: Mar. 28, 2019

(54) DEHYDRATION PROCESS AND PRODUCT

(71) Applicant: Albert R. Duoibes, East Grand Rapids, MI (US)

(72) Inventor: Albert R. Duoibes, East Grand Rapids, MI (US)

(21) Appl. No.: 16/139,707

(22) Filed: Sep. 24, 2018

Related U.S. Application Data
(60) Provisional application No. 62/563,388, filed on Sep. 26, 2017.

(51) Int. Cl. A23L 3/42

(52) U.S. Cl. CPC A23L 3/42; A23V 2002/00; A23V 2250/1878; A23V 2200/10; A23V 2250/1944; A23V 2300/10

(57) ABSTRACT

A food process and resulting product which includes (1) an initial dehydration of, and/or provision of dehydrated ingredients; (2) blending of the dehydrated ingredients sufficiently to form a dry aggregation; (3) oil enhancement of the dry aggregation; (4) rehydration of the ingredients; (5) agglomeration; and (6) final dehydration. The process results in a product that is a more attractive dehydrated product, more attractive and more pleasurable to eat when rehydrated, rehydrates faster, and remains fresh longer.

### PRIORITY

The present application claims priority to provisional application Ser. No. 62/563,388 filed Sep. 26, 2017, entitled DEHYDRATION PROCESS AND PRODUCT.

### FIELD OF INVENTION

The invention relates to the production of dehydrated food products or food products with dehydrated components,

### BACKGROUND OF THE INVENTION

While dehydration of food is an effective method of natural preservation, the resulting dulled color and soft texture of ingredients processed this way are not ideal for all food products. To preserve color in dehydrated food products, sulfites or other artificial ingredients commonly added. However, these compounds can result in symptoms of sensitivity. In addition, dehydrated products often look dull and uninviting, even when re-hydrated, and lack the appearance of fresh products that have not been dehydrated.

### SUMMARY OF INVENTION

The process of the present invention involves (1) providing disparate dehydrated food ingredients (by acquisition or dehydration); (2) blending dehydrated food ingredients sufficiently to create a dry aggregation of the disparate dehydrated ingredients; (3) oil enhancement of the dry aggregation; (4) rehydration of the disparate ingredients; (5) optional agglomeration of the disparate ingredients; and (6) final dehydration. The process results in a product that is a more attractive dehydrated product, more attractive and more pleasurable to eat when rehydrated, rehydrates faster, and remains fresh longer.

These and other features, objects and advantages of the invention will be more fully understood and appreciated by reference to the Description of the Preferred Embodiment, and to the attached photographic figures.

### BRIEF DESCRIPTION OF THE FIGURES

FIG. 1 is a photographic comparison of dehydrated patties made in accordance with the preferred embodiment of the invention with a comparable dehydrated dry product, in their respective dehydrated and rehydrated states.

### DESCRIPTION OF THE PREFERRED EMBODIMENTS

In the preferred embodiment, the desired ingredients are dehydrated or acquired as dehydrated ingredients, aggregated, subjected to oil enhancement and rehydrated, agglomerated and finally dehydrated as an agglomerated product. The intended food product can be designed for human or animal consumption, it can be a vegetable or fruit-based product, and can include meat or meat-based ingredients, or any combination of the forgoing. In addition, preservatives flavoring agents, sweeteners, fats, proteins, fruits, vegetables, nuts, grains, etc. can be incorporated into the initial ingredient aggregation, either prior to or during the initial dehydration.

Initial Dehydration: The initial dehydration process locks in nutrient content and begins breaking down cellular structures for improved absorptive properties in the next steps of the process. The term dehydration as used herein includes any of the known dehydration techniques, including without limitation, vacuum drying, freeze drying, infusion drying, convection drying, evaporation drying, oven drying, sun drying, drum drying, bed drying, microwave-vacuum drying, spray drying, thermal drying, infrared drying, and natural drying.

The ingredients chosen can be acquired as dehydrated ingredients, or can be dehydrated once acquired. Each ingredient can be a single component ingredient, e.g. a vegetable, fruit or meat, or can be an aggregation of components dehydrated together, such as flavoring ingredients. Naturally dry ingredients, including preservatives, are also referred to herein as initially dehydrated ingredients and can be incorporated into this aggregation either prior to or after the initial dehydration step.

The ingredients are dehydrated to a water activity sufficient to give them extended shelf life, without refrigeration. Preferably, the ingredients are dehydrated to a water activity of 0.6 or below.

Blending: The dehydrated ingredients are then blended sufficiently to form an aggregation of the dehydrated ingredients. Blending should be conducted to sufficient degree that the dehydrated components of the aggregation are generally uniformly distributed throughout the aggregation. The aggregation and oil enhancement can be done in a single step, as for example aggregating the ingredients into the oil.

Oil Enhancement: Oil enhancement not only contributes nutrient benefits and improves the flavor of a formula, but also works cooperatively alongside the natural enzyme and protein content of the rehydrated ingredients. Oil enhancement can be accomplished by blending oil into the blended aggregation of dehydrated food ingredients. Alternatively, the oil can be blended into the dehydrated food ingredients by introducing the oil into the disparate dehydrated food ingredients as they are being blended. Similarly, oil enhancement can be accomplished simultaneously with rehydration, by adding sufficient oil to the rehydration medium. However, the preferred methods involve oil enhancement prior to rehydration.

Oil enhancement is accomplished using vegetable oils comprised of short to medium chain fatty acids. Short chain fatty acids have less than 8 carbons on the chain, and medium chain fatty acids have a chain of 8-14 carbon atoms. A preferred chain length range is 6-14 carbons. A preferred vegetable oil is MCT oil, which is made by extracting the medium-chain triglycerides from coconut and/or palm oil. The preferred MCT oil is made of primarily 8 and 10 carbon chain fatty acids.

Preferably, the amount of oil used is from 2 to 10% by weight based on the weight of the blended aggregated ingredients. Most preferably, it is about 6% of the weight of the blended ingredient aggregation. Thus for 1,000 grams of dry aggregated ingredients, 60 grams of coconut oil would be used.

Rehydration: Rehydration of the oil enhanced ingredient aggregation reactivates the natural enzyme content of the dehydrated ingredients and facilitates blend uniformity and enzymatic equilibration both between the individual components of the disparate ingredients. The water containing rehydration medium can be water per se, or it can be the water content of a medium containing water. Thus, one might rehydrate the ingredients with a fruit juice, or a vitamin enriched water solution, a water solution of flavoring agents, preservatives, or a water-based slurry including additional desirable ingredients, such as sweeteners, fats, proteins, fruits, vegetables, nuts, grains, etc.

Sufficient water containing rehydration medium is used to rehydrate the aggregate blend to a pliable consistency. Typically, the water based medium will be used at about 25 to 100% by weight of the weight of the blended, dehydrated ingredients blend. Thus, for 1,000 grams of dry blend, 250-1,000 grams of rehydration medium will be used. More typically, about 500-750 grams of rehydration medium will be used, most preferably about 600 grams per 1,000 grams of dry blend.

Preferably, rehydration is accomplished by blending the rehydration medium into the oil enhanced dehydrated disparate ingredients.

Agglomeration: The term agglomeration as used herein refers to agglomeration of the oil treated, rehydrated ingredient blend into larger units of product which each contain a generally uniform blend of the various disparate ingredients. The units may be granules, pellets, or larger pressed or molded shapes, blocks or pucks. Agglomeration of the blended, oil treated aggregation can be accomplished during the rehydration process by rehydration blending of the disparate ingredients. The combined blending and rehydration process tends to cause the disparate ingredients to agglomerate together in larger aggregate units. The agglomeration process can be enhanced by rehydrating in rotating drum or other types of agglomerators. Similarly, larger units such as molded shapes, blocks, pucks or patties can be formed by pressing the pliable rehydrated aggregation in a press or mold. The particles may be agglomerated first into granules or pellets, and then pressed or molded into larger desired shapes.

The pressed product may comprise multiple layers of different aggregations made per the preferred embodiments. Thus, a vegetable only layer might be pressed against a meat only layer, or fruit only layer. Layers of different colored blends might be pressed and/or otherwise attached together.

In addition to forming pressed or molded shapes, blocks or patties from ingredients processed according to the present invention, one can incorporate other ready to use ingredients into the pressing or molding operation. Such ingredients may include nutritional supplements, flavor enhancers, treats, other preservatives, sweeteners, fats, proteins, fruits, vegetables, nuts, grains, etc., for functional or non-functional purposes. In the case of layered products, such ingredients may be inserted between the layers, either in layers themselves, or for pressing into the layers during the pressing process.

The newly bound, agglomerated ingredients interact, strengthening the fibers of the individual dehydrated ingredient/s and improving their fiber elasticity. The resulting final product will have a firmer, chewier, and more satisfying texture.

Final Dehydration: The final dehydration process serves to naturally preserve the formula and to stabilize the formula's newly enhanced color, texture, and form. The final dehydration is accomplished using any of the dehydration methods and equipment discussed above. As above, dehydration is continued until the product has a water activity sufficiently low that it has an extended shelf life without the need for refrigeration. Usually this means dehydration to a water activity of 0.6 or less, preferably 0.4 or less.

### EXAMPLE

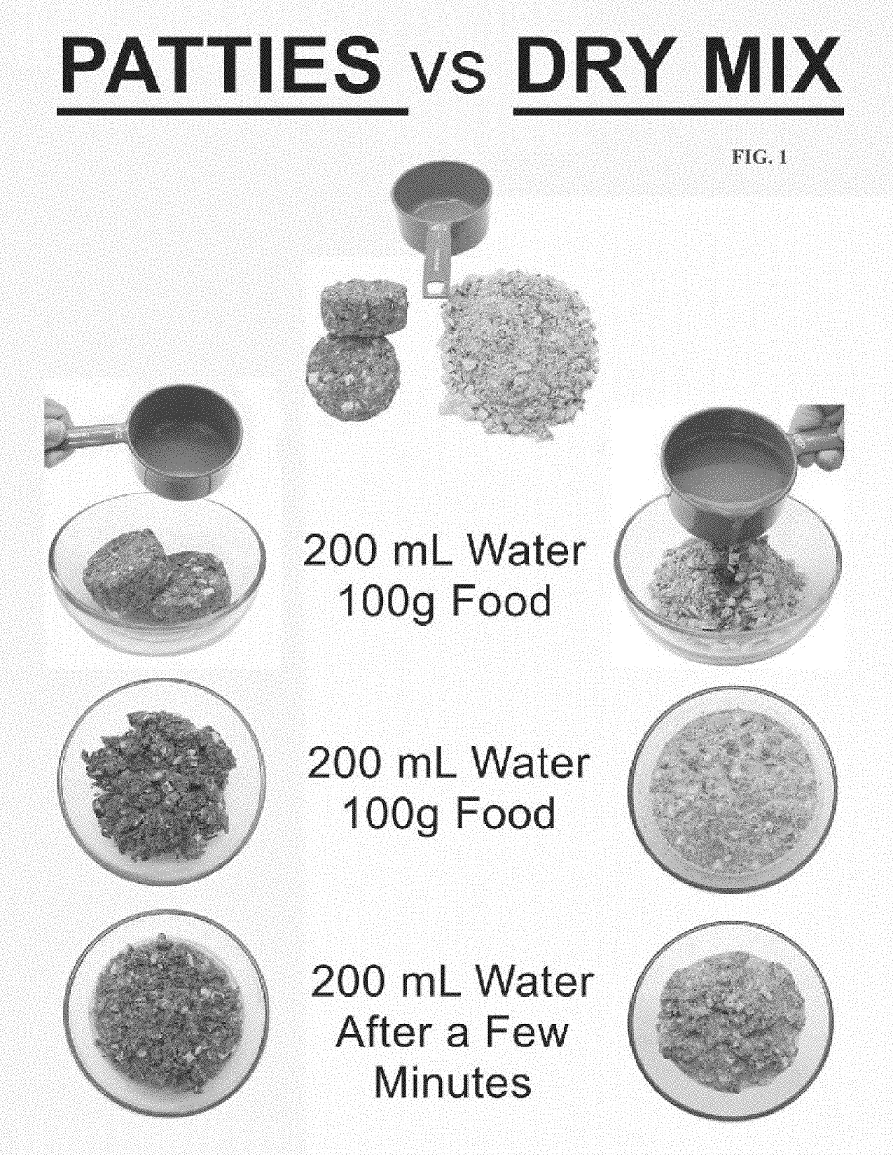

In one example, the following dehydrated ingredients were blended and presented as a dehydrated aggregate mixture, shown at the top right side of FIG. 1: Whole Eggs, Apples, Flaxseed, Kelp, Broccoli, Green Beans, Sweet Potatoes, Bananas, Blueberries, Parsley, Ginger, Celery, Lettuce, Watercress, Spinach, and a very small amount of Coconut Oil (1-2%) sprayed on as a dust suppressant.

These same dehydrated ingredients in the same proportions were also blended to a generally uniform aggregation of the disparate particles, and oil enhanced to create an oil treated aggregation blend in a ratio by weight of 95% dehydrated ingredients to 5% MCT oil. The resulting aggregation blend was rehydrated, agglomerated, pressed into patties and dehydrated, resulting in the dehydrated cakes shown at the top left side of FIG. 1. As shown in FIG. 1, 100 grams of each was then rehydrated with 200 mL of water. As seen by comparing the rehydrated product of the preferred embodiment on the left, with the rehydrated dry mix on the right, the rehydrated product of the present invention has a deeper more appetizing color and appearance than the rehydrated dry mix on the right. It also has superior mouth feel.

The patties used in the above example were tested for moisture and water activity, with the results as shown in Table 1 below:

TABLE 1

| Test Requested | Test Method | Results |
|---|---|---|
| Moisture | AOAC 950.46 | 4.18% |
| Water activity | TP-A034 | 0.32 |

The patties used were also tested for shelf life resistance to various common strains of mold, yeast and bacteria, with the results shown in Table 2 below:

TABLE 2

| Test Requested | Test Method | | Results |
|---|---|---|---|
| BAM: Mold | BAM Ch. 18 | Log: <1.0 | <10 cfu/g |
| BAM: Yeast | BAM Ch. 18 | Log: <1.0 | <10 cfu/g |
| Campylobacter | | Log: <1.0 | <10 cfu/g |
| Escherichia coli - | AOAC 991.14 | Log: <1.0 | <10 cfu/g |
| Generic | | | |
| Lactobacillus | | Log: 4.0 | 10000 cfu/g |
| Listeria Spp. | AOAC 070701 | | Negative/10 g |
| Salmonella | AOAC 2009.03 | | Negative/10 g |
| Staphylococcus | AOAC 2003.07 | Log: <1.0 | <10 cfu/g |
| Aureus | | | |
| Top 7 STEC (E. coli) | AOAC 071303 | | Negative/10 g |

Accordingly, it is evident from the test results of Tables 1 and 2 that the preferred embodiment product tested has excellent shelf life, resistance to common biotics, and desirably low water activity.

Conclusion:

Even without the addition of sulfites, the dehydrated agglomerated ingredients have a richer color; firmer, more natural texture; a uniform dispersion of added fat content; rehydrate faster; and because of their lowered water content, have a longer shelf-life when compared to dehydrated ingredients. The preferred embodiment process of dehydration results in a product that is more attractive, more pleasurable to eat, rehydrates faster, and remains fresh longer.

It is understood that the above are preferred embodiments of the invention, and that various changes and alterations can be made within the scope of the invention.

1. A process for food dehydration comprising: providing disparate dehydrated food ingredients; blending said disparate dehydrated food ingredients sufficiently to create a dry aggregation of said disparate dehydrated ingredients; performing oil enhancement of said disparate dehydrated food ingredients; rehydrating said disparate ingredients; and then performing a final dehydration of said aggregation.

2. The process of claim 1 in which said aggregation of ingredients are agglomerated after rehydration and prior to final dehydration.

3. The process of claim 2 in which said disparate dehydrated food ingredients have been dehydrated to o a water activity of 0.6 or below.

4. The process of claim 3 in which said oil enhancement is accomplished using vegetable oils comprised of short to medium chain fatty acids having a chain length range is 6-14 carbons.

5. The process of claim 4 in which said vegetable oil is MCT oil, made by extracting the medium-chain triglycerides from coconut and/or palm oil.

6. The process of claim 5 in which the amount of oil used in said oil enhancement is from 2 to 10% by weight based on the weight of the blended aggregated ingredients.

7. The process of claim 6 in which said rehydration step is accomplished using sufficient water containing rehydration medium to rehydrate the aggregate blend to a pliable consistency.

8. The process of claim 7 in which said rehydration medium is used at about 25 to 100% by weight of the weight of the blended, dehydrated ingredients blend.

9. The process of claim 8 in which said rehydration is accomplished by blending said rehydration medium into dehydrated disparate ingredients after said oil enhancement step.

10. The process of claim 9 in which said rehydration medium comprises one or more of the following: a fruit juice; a vitamin enriched water solution; a water solution of flavoring agents; a water solution of preservatives; or a water-based slurry including additional desirable ingredients, such as sweeteners, fats, proteins, fruits, vegetables, nuts, grains, or the like.

11. The process of claim 10 in which said aggregation is agglomerated into one of: granules, pellets, larger pressed shapes, larger molded shapes, blocks or pucks.

12. The process of claim 11 in which said agglomeration of said blended oil enhanced aggregation is accomplished during said final rehydration.

13. The process of claim 12 in which one or more of the following additional ingredients are incorporated into the final product during said agglomeration step: nutritional supplements, flavor enhancers, treats, other preservatives, sweeteners, fats, proteins, fruits, vegetables, nuts, grains, etc., for functional or non-functional purposes.

14. The process of claim 13 in which said agglomeration step includes forming separate layers of said different blended oil enhanced aggregations; said separate layers being pressed together to form an integral finished product.

15. The process of claim 14 in which said one or more additional ingredients are added by insertion between said layers for pressing into said layers during said pressing process.

16. The process of claim 11 in which said final dehydration is to a water activity of 0.6 or less, preferably 0.4 or less.

17. The process of claim 1 in which said oil enhancement is accomplished using vegetable oils comprised of short to medium chain fatty acids having a chain length range is 6-14 carbons.

18. The process of claim 17 in which the amount of oil used in said oil enhancement is from 2 to 10% by weight based on the weight of the blended aggregated ingredients.

19. The process of claim 18 in which said rehydration step is accomplished using sufficient water containing rehydration medium to rehydrate the aggregate blend to a pliable consistency, said rehydration medium being used at about 25 to 100% by weight of the weight of the blended, dehydrated ingredients blend.

20. A dehydrated food product made by the process of claim 1.

21. The dehydrated food product of claim 20 in which said aggregation of ingredients are agglomerated after rehydration and prior to final dehydration.

22. The dehydrated food product of claim 21 which comprises: multiple layers of different ones of said aggregations, pressed together to form an integral multilayer product.
